(19) United States
(12) Patent Application Publication
(10) Pub. No.: US 2003/0145513 A1
(43) Pub. Date: Aug. 7, 2003

(54) Defoaming agent for liquid hydrocarbons I

(76) Inventors: David Herault, Koeln (DE); Benoit Abribat, Loveland, OH (US); Frank Bongardt, Meersbusch (DE); Achim Pfeiffer, Duesseldorf (DE)

Correspondence Address: COGNIS CORPORATION, 2500 RENAISSANCE BLVD., SUITE 200, GULPH MILLS, PA, 19406

(21) Appl. No.: 10/203,858

(22) PCT Filed: Feb. 6, 2001
(86) PCT No.: PCT/EP01/01241

(30) Foreign Application Priority Data
Feb. 15, 2000 (DE) 10006623.2

(51) Int. Cl. C10L 1/18; C08K 5/01

(52) U.S. Cl. 44/447; 524/543

(57) ABSTRACT

The invention relates to a method for defoaming liquid hydrocarbons, whereby these vinyl alkylether polymerizates of general formula (I), in which R represents a saturated or unsaturated, straight or branched alkyl radical with 2 to 18 C atoms, and n represents a number >1, are added in quantities ranging from 1 to 2000 ppm.

The present invention relates to the use of polymeric vinyl alkyl ethers for defoaming liquid hydrocarbons, a process for defoaming liquid hydrocarbons and also additives for defoaming liquid hydrocarbons.

In the field of lubricant technology, the high demands placed on lubricants today dictate not only that suitable base oils be used but also that their performance be supplemented and improved by various additives. Examples of such additives include oxidation inhibitors, viscosity index improvers, pour point depressants, detergents and dispersants, high pressure (HP) additives, friction modifiers and defoamers. The latter are required because many lubricant oils tend to foam which can sometimes drastically reduce the performance of the lubricant, in particular in closed lubricant circuits. Foaming of lubricants accordingly has to be avoided at all costs. The problem of foaming of lubricants is normally solved by incorporating foam inhibitors in the lubricants, for example, low molecular weight silicone oils or alkyl polyacrylates. Preference is given to using low molecular weight silicone oils such as polydimethylsiloxanes, fluorosilicones or silicone glycols for this purpose. However, silicones have the disadvantage that, in organic liquids which are then subjected to combustion, the reaction of the organosilicone polymer with oxygen leads to the formation of silicon oxides, which in finely divided form firstly cause environmental pollution and secondly lead to problems with filters and catalysts in the system to be lubricated. This problem occurs in particular in the automobile sector or more precisely in internal combustion engines. U.S. Pat. No. 3,166,508 discloses defoamers for hydrocarbons based on alkyl acrylate polymers having a molecular weight of less than 10 000. However, such defoamers show a lower foam-inhibiting effect than the prior art silicone oils. WO 94/06894 discloses reaction products of polyamines with carboxylic acids as defoamers or foam inhibitors for organic liquids. In this case, disadvantages occur in that insufficient long-term stabilities were detected and the products were in the form of fine particles, which complicates their use in lubricant oils in motor vehicles. Also, defoamers for lubricants, for example in gearboxes, have to maintain their effectiveness over a wide temperature range, frequently up to 80° C. or 100° C.

The object of the present invention, then, was to provide suitable defoamers for liquid hydrocarbons which fulfill the abovementioned requirements. These shall in particular achieve defoaming performance on the order of magnitude of the known silicone defoamers, without the danger of formation of solid particles during combustion being observed. It was also required that the defoamer effect should be retained over a wide temperature range.

Surprisingly, it was found that certain alkyl vinyl ether derivatives fulfill the abovementioned requirements. Such compounds are already known in principle to those skilled in the art from U.S. Pat. No. 3,127,352. However, this document discloses exclusively high molecular weight polymers of polyvinyl ethers as defoamers. Those skilled in the art are taught that the molecular weight of the polymers has to be at least 150 000. The document clearly states that the polymers lose their defoaming performance for liquid hydrocarbons with falling molecular weight and are ineffective below a molecular weight of 150 000. In contrast, it was surprisingly found that the low molecular weight compounds are also suitable defoamers for liquid hydrocarbons.

Accordingly, a first embodiment claims the use of vinyl alkyl ether compounds of the general formula (I)

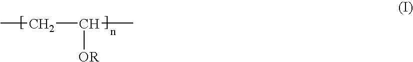

where R is a saturated or unsaturated, linear or branched alkyl radical having from 2 to 18 carbon atoms and n is a number greater than 1, as defoamers for liquid hydrocarbons. The formula (I) shows a section of the polymer, the ends of the molecules generally being saturated by hydrogen atoms.

In the context of the present application, the term defoamer is used synonymously with the expression foam inhibitor or foam-preventing reagent. The effect of the present compound can be regarded as the suppression of foam formation or the faster degradation of foam which is already formed. The polymers to be used according to the present technical teaching are compounds known per se which can be prepared from suitable monomers by polymerization processes known to those skilled in the art. Examples of alkyl vinyl ethers which are suitable for preparing the polymers to be used according to the invention include ethyl, bothyl, isobothyl, ethylhexyl, octyl, decyl, hexadecyl and octadecyl vinyl ether. The polymers of alkyl vinyl ethers can be prepared in a manner known per se, for example, using cationic initiators such as Lewis acids, for example, BF₃, AlCl₃, SnCl₄ or complexes thereof with ethers, or else metal sulfates such as Al₂(SO₄)₃·7 H₂O. Such polymerization processes are described in “Methoden der organischen Chemie” of Houben-Weyl, Georg Thieme Verlag, Stuttgart, vol. XIV/1, pages 927 ff. The polymers to be used according to the invention may be homopolymers or mixed polymers of alkyl vinyl ethers having different alkyl radicals. Particular preference is given to using polymers of alkyl vinyl ethers whose alkyl radical has from 4 to 10 carbon atoms, in particular 4 carbon atoms. Polymers of alkyl vinyl ethers whose alkyl radical is branched generally show a higher effectiveness than polymers of alkyl vinyl ethers having straight-chain alkyl radicals. Accordingly, particular preference is given to polymers of alkyl vinyl ethers whose alkyl radical is the isobutyl radical. When polymers of alkyl vinyl ethers whose alkyl radical has more than 6 carbon atoms is used, the lower limit of the molecular weight should if possible be chosen in such a way that the oligomeric alkyl ethers have at least 3 vinyl units. It has also proven advantageous to use vinyl alkyl ether compounds of the formula (I) whose average molecular weight M_{w} is in the range from 400 to a maximum of 140 000. The weight average molecular weight M_{w} is defined as M_{w}=sum of nᵢ×Mᵢ²/ sum of nᵢ×Mᵢ, where nᵢ is the number of moles having the molecular weight Mᵢ (from Houben-Weyl “Methoden der organischen Chemie”, Georg Thieme Verlag, Stuttgart, vol. XIV/1, page 19). The molecular weight Mᵢ may be determined, for example, by gel chromatography or viscometry. In particularly preferred embodiments, vinyl alkyl ether compounds of the general formula (I) having average molecular weights M_{w} in the range from 1000 to 120 000 and in particular from 2000 to 115 000 are used. A further preferred range is from 100 000 to 125 000.

On the basis of the number average molecular weight Mₙ, preference is given to those polymers whose Mₙ values are in the range from 1000 to 50 000 and in particular from 10 000 to 35 000 and more preferably in the range from 15 000 to 25 000. As well as the alkyl radicals already mentioned above, those having from 6 to 16 and 8 to 12 and also from 4 to 10 carbon atoms have also proven to be particularly suitable. Particular preference is given to the isobutyl radical.

The compound according to formula (I) are added to liquid hydrocarbon quantities in quantities of from 1 to 2000 ppm, preferably from 5 to 1000 ppm and in particular from 10 to 500 ppm (based in each case on the active substance of the formula (I)). The polymers used according to the invention show a defoaming effectiveness comparable to the known silicone compounds without their disadvantages, in particular the formation of solid particles. The polymers used according to the invention are suitable for defoaming hydrocarbons which are liquid at room temperature (21° C.). In the present application, the term hydrocarbons is used in a wide sense. It does not only include crude oil raffinates, such as gasoline or diesel oil, but also base oils for lubricants in general which encompass not only polymers of olefins, condensation products of olefins or chloroparaffins with aromatics, and dechlorinated condensates of chloroparaffins, but also polyethers, carboxylic esters, phosphoric esters, phosphonic esters and also fluorinated compounds which are known to those skilled in the art as lubricants. Preference is given to using the compounds of the formula (I) for defoaming synthetic lubricants which comprise ester oils. The ester oils are compounds which are formed firstly from branched-chain primary alcohols and straight-chain dicarboxylic acids, from branched-chain monocarboxylic acids and straight-chain diols or polyalkylene glycols, from straight-chain primary alcohols and branched dicarboxylic acids or, in particular, from esters of neopentyl polyols with monocarboxylic acids. The alcohols required for preparing such ester oils are obtained from the oxo process or aldol condensation. In principle, all olefins are suitable for the oxo process, but for later use of the alcohols as ester oil components, preference is given to using tri- or tetrapropylene, diisobutene, mixed dimers of propylene and n-butene and also butenes or pentenes. The oxo process alcohols are esterified as isomer mixtures, whereas the alcohols obtained by aldol condensation, for example, the 2-ethylhexan-1-ol obtained from n-butanal, are esterified as a substantially unitary compound. The most important dicarboxylic acids are sebacic acid, adipic acid and azelaic acid. Perlagonic acid which, as well as azelaic acid, results from the oxidation of oleic acid, is available as a monocarboxylic acid. Sebacic acid is obtained by alkaline cleavage of ricinoleic acid. The esters are prepared from acid and alcohol in the presence of acid catalysts and with distillative removal of the water formed, using benzene or toluene. Particular importance attaches to what are known as the complex esters which are prepared using dicarboxylic acids, glycols (or polyglycols) and monocarboxylic acids of monoalcohols. Depending on the desired product, glycol and dicarboxylic acid are first esterified and the end groups of this intermediate, depending on the molar ratio of the two components, are either reacted with a monocarboxylic acid or a monoalcohol. The complex esters have higher molecular masses than the simple esters and accordingly substantially higher intrinsic viscosities. Further details of such compounds can be found, for example, in Ullmanns Encyklopädie der technischen Chemie, 4th edition, 1981, pages 514 ff. Further suitable lubricants include perfluoropolyalkyl ethers, tetrahydrofuran polymer oils, polythioether oils, polyphenyl ethers, ethylene and propylene polymers, polybutenes and polymers of higher olefins. The present vinyl alkyl ether compounds are also suitable for defoaming mixtures of these different base oils.

According to the invention, the vinyl alkyl ether compounds of the general formula (I) are added directly to the lubricant or hydrocarbon to be defoamed. The hydrocarbons according to the present invention are generally water-free, i.e. they contain water in quantities of less than 1% by weight, preferably in the ppm range of less than 500 ppm. Where diesel and gasolines are concerned, preference is given to those hydrocarbons whose sulfur content is reduced. The sulfur content of such hydrocarbons is preferably below 50 ppm, in particular in the range of less than 10 ppm. When compounds of the formula (I) according to the invention are used, it has proven advantageous to combine these with other compounds to give an additive which is then added to the media to be defoamed. Preference is given to mixing the compounds of the formula (I) with selected solvents and then using them. Such solvents are selected from the group consisting of liquid esters of the general formula (II)

R′—COO—R″ (II)

where R′ and R″ are each independently saturated or unsaturated, linear or branched alkyl radicals having from 6 to 16 carbon atoms. These esters are obtained by reacting monoalcohols of the preferred chain length C6 to C16 with monohydric carboxylic acids of the chain length C6 to C16, preferably C8 to C12. In this context, particular preference is given to using octyl octanoate as solvent. Further preferred carboxylic acids for preparing esters of the formula (II) are caproic, heptanoic, caprylic, perlagonic, capric, lauric, myristic and palmitic acid. Useful alcohol components are selected from the group consisting of hexanol, heptanol, octanol, nonanol, decanol, undecanol, dodecanol, tridecanol, tetradecanol, pentadecanol and hexadecanol. An example of a useful unsaturated alcohol is undecen-1-ol. The compounds of the formula (II) are in principle esters of primary alcohols with monocarboxylic acids.

A further advantageous embodiment of the teaching according to the invention provides the combination the compounds of the formula (I), preferably in combination with the solvents of the formula (II) and further additives selected from the group consisting of the alkoxylated alcohols. In particular, alcohols having from 2 to 6 carbon atoms and from 2 to 4 hydroxyl groups are used which are prepared by known methods, i.e. under pressure in the presence of acid or basic catalysts, using from 1 to 50 mol of ethylene oxide and/or propylene oxide per mole of alcohol. Preference is given to using alkoxylated polyols which have been reacted with from 10 to 30 mol of ethylene oxide and/or propylene oxide per mole of alcohol. However, fatty alcohols having from 6 to 24 carbon atoms which have been reacted with from 1 to 30 mol of alkoxide per mole of alcohol are also suitable. Preference is given firstly to using the reaction products of glycerol with ethylene oxide and/or propylene oxide, mixed polymers of ethylene and propylene oxide being particularly suitable compounds. Secondly, polyalkylene glycols find use. When polyol alkoxides are used, preference is given to alkoxylating all OH groups of the polyols.

A further part of the subject matter of the invention relates to the combination of defoamers of the formula (I) with nonalkoxylated esters of polyols having from 2 to 6 carbon atoms and from 2 to 4 OH groups and saturated or unsaturated, linear or branched fatty acids having from 8 to 24 carbon atoms. It has been observed that the additional use of such compounds can have a synergistic effect on the defoaming performance. Preference is given to room temperature liquid triglycerides which are of natural, in particular plant, origin. Examples thereof include rapeseed oil, sunflower oil, soya oil, coconut oil and castor oil. Particular preference is given to combining defoamers of the formula (I) with solvents and the triglycerides, and the additional use of alkoxylated alcohols may also be preferable.

A further part of the subject matter of the present invention relates to additives for defoaming liquid hydrocarbons, in particular lubricants, and the additives preferably contain a) from 1 to 50% by weight of a compound of the formula (I), b) from 1 to 99% by weight of a liquid ester of the formula (II) and also c) from 0 to 50% by weight of an alkoxylated alcohol and d) from 0 to 5% by weight of a polyol ester. Particular preference is given to additives which contain a) from 5 to 15% by weight of a compound of the formula (I), b) from 10 to 95% by weight of a liquid ester of the formula (II) and also from 5 to 20% by weight of an alkoxylated alcohol, preferably an alkoxylated polyol, and d) from 0 to 5% by weight of a plant triglyceride.

It is also possible to supplement the additives according to the invention by adding further additives known in the lubricant sector, for example, VI improvers, corrosion inhibitors, antioxidants, friction modifiers, HP additives, etc., and to adapt their performance to the requirements of each practical use. The present invention also relates to a process for defoaming liquid hydrocarbons, wherein compounds of the formula (I) are added to the liquid hydrocarbons in quantities of from 1 to 2000 ppm (of active substance).

### EXAMPLES

In order to demonstrate the effectiveness of the technical teaching according to the invention, defoamer tests were carried out to ASTM D892. To this end, 200 ml of the hydrocarbon were prepared with the additives to be tested in the desired concentrations and heated to different temperatures. 190 ml of this solution are transferred to a 1000 ml upright cylinder. A gas distributor (sinter brick) is then saturated for five minutes and air is blown through the solution for two minutes (400 1 per hour volume). The foam volume was read off (in ml) and noted.

In the present case, five different additives according to the invention in two transmission oils were investigated at 20, 60 and 90° C. As a comparison (C), the oils were measured without additives or with addition of a prior art silicone defoamer. The results without defoamer (B) are also reported.

The composition of the additives according to the invention is reported in table 1. The results of the foam height measurements for three different temperatures are found in table 2.

TABLE 1

| | Octyl | Polyvinyl | Polyalkylene | Coconut |
|---|---|---|---|---|
| | ocanoate | isobutyl ether | glycol | oil |
| | % by weight | % by weight | % by weight | % by weight |
| 1 | 90 | 10 | — | — |
| 2 | 94 | 1 | 5 | — |
| 3 | 85 | 5 | 10 | — |
| 4 | 75 | 5 | 20 | — |
| 5 | 94 | 5 | — | 1 |

TABLE 2

| | Transmission oil I | | | Transmission oil II | | |
|---|---|---|---|---|---|---|
| | 20° C. | 60° C. | 90° C. | 20° C. | 60° C. | 90° C. |
| | h (ml) | h (ml) | h (ml) | h (ml) | h (ml) | h (ml) |
| 1 | 100 | 340 | 290* | — | 850 | — |
| 2 | — | — | 350* | — | 400* | — |
| 3 | 120 | 170* | 340* | — | 360* | — |
| 4 | 170 | — | — | — | — | — |
| 5 | 260 | 250* | 460* | — | 230* | 285** |
| C | 90*** | 140*** | 350*** | 141*** | 270*** | 122 |
| B | 530 | 900 | 1000 | 550 | 680 | >600 |

*500 ppm dose
**1000 ppm dose
***25 ppm dose
100 ppm dose unless stated otherwise

The transmission oil I is a synthetic rear axle transmission oil based on polyalphaolefin and diisodecyl adipate+15% by weight of EP/AW additive. The transmission oil II is based on trimethylolpropane complex esters+1.5% by weight of antioxidant.

The preparations according to the invention lead to a distinct reduction compared to the defoamer-free oils. The performance of the preparations according to the invention is comparable to that of the prior art silicone oil products. The combination with the natural triglycerides (preparation No. 5) shows a particularly distinct defoaming effect.

1. The use of vinyl alkyl ether compounds of the general formula (I) 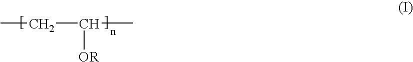
where R is a saturated or unsaturated, linear or branched alkyl radical having from 2 to 18 carbon atoms and n is a number >1, as defoamers for liquid hydrocarbons.

2. The use as claimed in claim 1, characterized in that the compounds of the formula (I) have an average molecular weight M_{w} of from 400 to 140 000, preferably from 1000 to 120 000 and in particular from 2000 to 115 000.

3. The use as claimed in claim 1 or 2, characterized in that R is an alkyl radical having from 6 to 16 carbon atoms, preferably from 8 to 12 carbon atoms and in particular from 4 to 10 carbon atoms.

4. The use as claimed in any of claims 1 to 3, characterized in that R is a branched saturated alkyl radical, preferably an isobutyl radical.

5. The use as claimed in any of claims 1 to 4, characterized in that the compounds of the formula (I) are added to the liquid hydrocarbons in quantities of from 1 to 2000 ppm, preferably from 5 to 1000 ppm and in particular from 1 to 100 ppm (of active substance).

6. The use as claimed in any of claims 1 to 5, characterized in that the liquid hydrocarbons are selected from the group consisting of room temperature liquid alkanes and alkenes, gasoline, diesel oil and also polymer oils, ester oils or primary alcohols and dicarboxylic acids, ester oils of monocarboxylic acids and diols or polyalkylene glycols, ester oils of neopentyl polyols with monocarboxylic acids, polyether oils and mixtures thereof.

7. The use as claimed in any of claims 1 to 6, characterized in that the compounds of the formula (I) are added to liquid hydrocarbons.

8. The use of compounds of the formula (I) for defoaming lubricants.

9. A process for defoaming liquid hydrocarbons, characterized in that compounds of the formula (I) as claimed in claim 1 are added to the liquid hydrocarbons in quantities of from 1 to 2000 ppm (of active substance).

10. The process as claimed in claim 9, characterized in that the compounds of the formula (I) are dissolved in solvents selected from the group consisting of the liquid esters of the general formula (II)
R′—COOO—R″ (II)
where R′ and R″ are saturated or unsaturated, linear or branched monovalent alkyl radicals having from 6 to 16 carbon atoms, and the solution is then added to the liquid hydrocarbons.

11. The process as claimed in claim 9 or 10, characterized in that the compounds of the formula (I) are dissolved in octyl octanoate and then added to the liquid hydrocarbons.

12. The process as claimed in any of claims 9 to 11, characterized in that the compounds of the formula (I) are added to the liquid hydrocarbons together with alkoxylated alcohols.

13. The process as claimed in any of claims 9 to 12, characterized in that the compounds of the formula (I) are used together with esters of polyols having from 2 to 6 carbon atoms and from 2 to 4 hydroxyl groups and fatty acids having from 6 to 24 carbon atoms.

14. The process as claimed in any of claims 9 to 13, characterized in that the compounds of the formula (I) are used together with triglycerides of plant origin, preferably coconut oil.

15. An additive for defoaming liquid hydrocarbons comprising
a) from 1 to 50% by weight of a compound of the formula (I) as claimed in claim 1
b) from 1 to 99% by weight of a liquid ester of the formula (II) as claimed in claim 10
c) from 0 to 50% by weight of an alkoxylated alcohol
d) from 0 to 5% by weight of a polyol ester.

16. The additive as claimed in claim 15, characterized in that it comprises
a) from 5 to 15% by weight of a compound of the formula (I)
b) from 10 to 95% by weight of a liquid ester of the formula (II)
c) from 5 to 20% by weight of an alkoxylated alcohol
d) from 0 to 5% by weight of a natural triglyceride.
